(19) United States
(12) Patent Application Publication
(10) Pub. No.: US 2012/0050066 A1
(43) Pub. Date: Mar. 1, 2012

(54) MOBILE DEVICE USER INTERFACE FOR HEALTH MONITORING SYSTEM

(75) Inventor: Ajit Pendse, Durham, NC (US)

(73) Assignee: pomdevices, LLC, Durham, NC (US)

(21) Appl. No.: 13/217,649

(22) Filed: Aug. 25, 2011

Related U.S. Application Data
(60) Provisional application No. 61/377,275, filed on Aug. 26, 2010.

(51) Int. Cl. G08C 19/22

(52) U.S. Cl. 340/870.07

(57) ABSTRACT

In one example, a portable device comprises a processing device configured to monitor the health of a user and notify a caregiver according to the monitoring. The portable device also comprises a network connection configured to utilize a network protocol to interface with a display of a mobile device and output an image related to the monitoring on the display.

This application is a non-provisional of U.S. Provisional Application No. 61/377,275 filed on Aug. 26, 2010, entitled: SMART PHONE USER INTERFACE FOR HEALTH MONITORING SYSTEM, which is herein incorporated by reference in its entirety.

### COPYRIGHT NOTICE

© 2010-2011 pomdevices, LLC. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### BACKGROUND OF THE INVENTION

Early detection of a decline in health, especially cognitive health, in an older adult can be critical for effective treatment. Checkups at medical facilities can be useful for early detection, but are sometimes too infrequent to provide immediate detection of a decline in health, especially cognitive health where declines can happen rapidly and without being easily noticed by friends and family.

Systems for monitoring health remotely with respect to the medical facilities, for example monitoring health in the home, do exist. Some of these existing systems fail to make adequate use of resources that may already be available in the home of the older adult, which can result in these existing systems being prohibitively expensive and/or difficult to deploy. The disclosure that follows solves these and other problems.

### SUMMARY OF THE INVENTION

As mobile device manufacturers, i.e. manufactures of mobile phones, tablet PCs, handheld GPS devices, and other mobile electronic devices, continue to race toward the largest, highest resolution, most intuitive user interfaces, we propose that non-mobile device manufacturers may supply value-added computing devices (or “compute stations”) that are not restricted to native displays, although they may have one, but in any case are capable of utilizing the displays that are native in mobile computing devices. In addition, mobile computing devices include various user input mechanisms, for example a keyboard, microphone, touch screen or any combination thereof. We further propose utilizing one or more user input mechanisms of a mobile device, such as a touch screen, to provide a user input interface to a compute station.

Others have introduced limited “tethering” solutions in which a mobile device internet connection can be shared (e.g., via Bluetooth® or USB) with a computer. We use “computer” in the broad sense, in no way intended to be limited to a conventional PC or laptop computer.

In an embodiment, we propose a solution for utilizing mobile displays as pass-through devices for domain-specific hardware devices within a common and closed network infrastructure (i.e., the native device and the mobile display). In one aspect, we disclose a compute station, which may be operate as a stationary docking station for any number of mobile device(s) in a health monitoring system. We use a health monitoring system as the compute station by way of illustration and not limitation. We disclose a network connection in the compute station allowing transfer of open data to the mobile display. The network connection may employ a dock/cable connection (for example, USB), or any short-range wireless technology such as Bluetooth®.

In an embodiment, the compute station is intended to be a stand-alone device. It may or may not have an integrated output display screen. The compute station may contain standard computer hardware (CPU, memory, etc.) and may have various input methods for gathering information. Input mechanisms may include sensor receivers, internet connections, the mobile display device itself, or other wireless communication tools, such as Bluetooth®. The input gathered by the compute station is then processed by the onboard operating system and software programs.

### BRIEF DESCRIPTION OF THE DRAWINGS

FIG. 1A illustrates a portable patient computing device (a compute station) having a mobile device user interface.

FIG. 1B illustrates a daily activity trend detection and notification process 101 that may be performed, in part, by the compute station shown in FIG. 1A.

FIG. 2 illustrates a simplified perspective view of one embodiment showing a mobile device tethered to a base computing system—for example, a portable patient computing device—for health care monitoring and related applications.

FIG. 3 illustrates the compute station communicating with a caregiver computing device through the mobile device.

### DETAILED DESCRIPTION OF PREFERRED EMBODIMENTS

Health monitoring systems can be used to help older adults or other persons who have physical impairments or limitations to live independently in their homes while facilitating important communications with remote caregivers. For example, such systems can send and receive messages, track normal activity patterns, and warn of any changes. They may also provide medication and appointment reminders, and call 911 in an emergency.

In an example health monitoring system, patient activities are detected or monitored by a variety of electronic input sources. Data representing the activities are transmitted to a central device (on site or remote) where the data are archived, i.e., accumulated over time. A software process analyzes the input data from a given source and detects changes over time, for example by use of a moving average or other statistical metrics. Significant results or changes in those metrics trigger notification to a caregiver or other designated party. In another embodiment, the input data from multiple sources is analyzed against previous data.

In one example, a process used by the health monitoring system includes receiving a plurality of first communications and a plurality of second communications, each first communication capturing activity of a patient using a first device at a different time and each second communication capturing activity of the patient using a second device at a different time. The process includes identifying a macro trend for all monitored activity of the patient based on data taken from the first and second communications. The process includes comparing data taken from a new communication from at least one of the first and second devices to the identified macro trend. A caregiver may be notified according to the comparison.

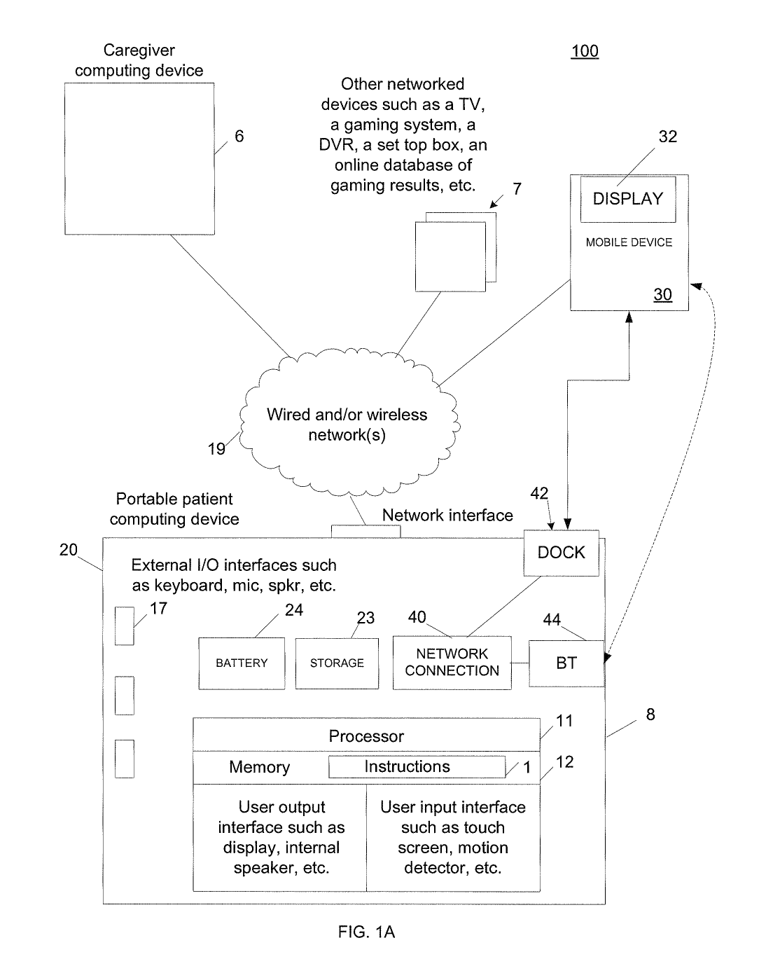

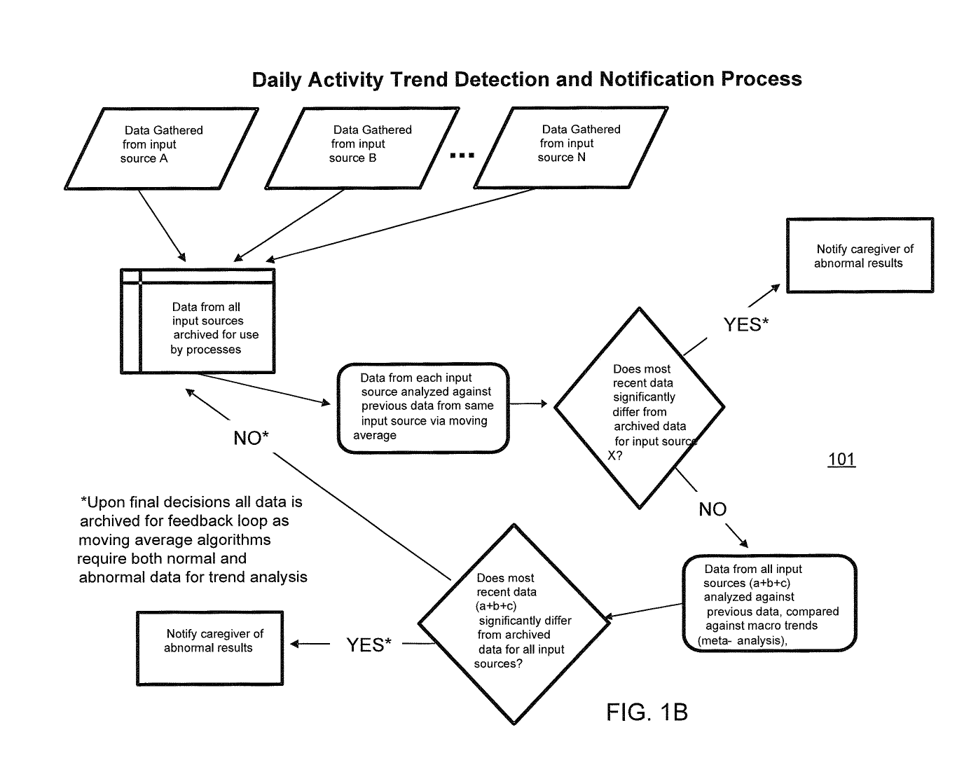

FIG. 1A illustrates a portable patient computing device (a compute device) having a mobile device user interface. In one embodiment, a health system 100 includes a caregiver computing device 6 which is typically situated remotely from a compute station 8, which may be powered by a battery 24. The processor 11 of compute station 8 may be configured to, alone or in combination with processing performed by a processor of caregiver computing device 6, perform the process 101 shown in FIG. 1B, which is described in more detail in commonly-owned U.S. patent application Ser. No. 13/104,371 filed on May 10, 2011 entitled “ACTIVITY TREND DETECTION AND NOTIFICATION TO A CAREGIVER”, which is herein incorporated by reference in its entirety. The devices from which the information can be collected can include a sensor of the compute station 8 and/or remote devices (including but not limited to the mobile device 30).

Referring again to FIG. 1A, communications between the devices 6 and 8 may use SMS/text messaging, email, and/or other forms of communication. The storage 23 can be used to store extracted data between transmissions. Other networked devices 7 may communicate with compute station 8 via a wired or wireless network 19. The compute station 8 includes a network interface 20 for connection to the network 19. The compute station 8 typically includes a processor 11 and a memory 12 storing instructions 1. External I/O interfaces 17 may include, without limitation, keyboard, microphone, speaker, etc., each of which may be wired (cabled) or wireless connections. Other illustrative interfaces are listed in the drawing FIG. 1A.

A network connection 40 (not to be confused with the network interface 20) is an embedded system within the compute station 8 that acts as the interface to a mobile device 30, including without limitation interfacing to the display 32 of the mobile device 30. The network connection 40 may implement any of various known network protocols for interfacing with the mobile device 30 and its display 32, including for example USB, Bluetooth®, Ethernet, SSL, SSH, and so on. A dock 42 connected to the network connection 40 may be used for convenient connection of the compute station 8 to the mobile device 30. Alternatively or in addition, the network connection 40 may implement or use a short-range wireless connection (e.g. BT 44) for communication with the mobile device 30. The network connection may be used for network access (internet, telecom etc) when available instead of the network interface 20.

The compute station 8 utilizes the network connection 40 to send information when the mobile device 30 is either physically docked 42 or within communication range. This information can include, for example:

1. An application required to provide a framework for the compute station 8 to utilize interface features of the mobile device.
2. Application specific display parameters (sent after the compute station 8 is aware of the mobile device 30 currently on the network).
3. Application specific processed information gathered from the stationary platform inputs.

After docking (pairing), the mobile device display 32 may use either a preloaded application, or the application downloaded from the compute station 8, to display information to a user, thus allowing for a seamless communication between the compute station 8 and the display device 32 of the mobile device 30, without requiring user action. In addition, the mobile device 30 may implement user input mechanisms, as noted above. For example, the display screen 32 may be an interactive display such as a touch screen. Input data can be passed from the interactive display to the compute station 8 using the various interfaces and protocols summarized above.

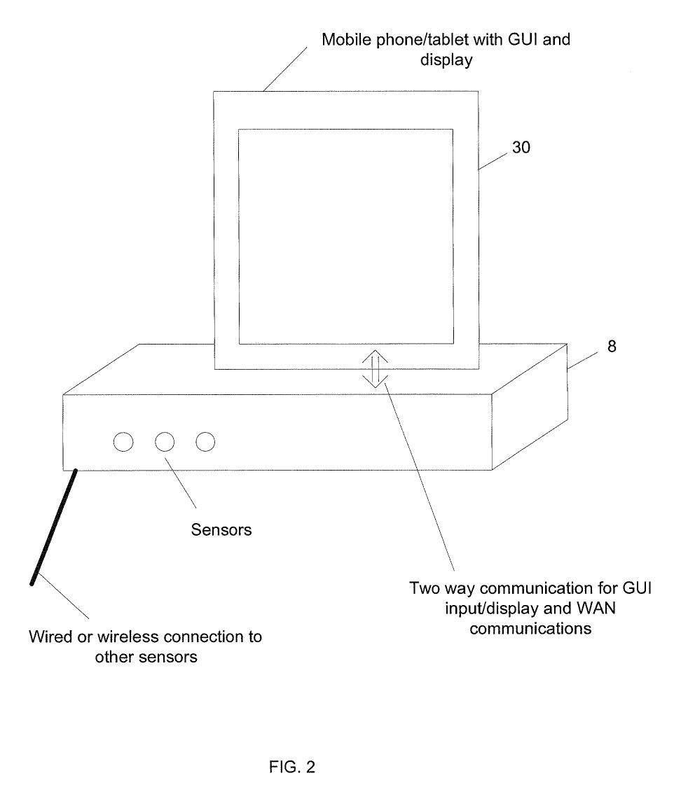

FIG. 2 illustrates a simplified perspective view of one embodiment showing a mobile device 30 tethered to a base computing system, for example, a compute station 8 for health care monitoring and related applications.

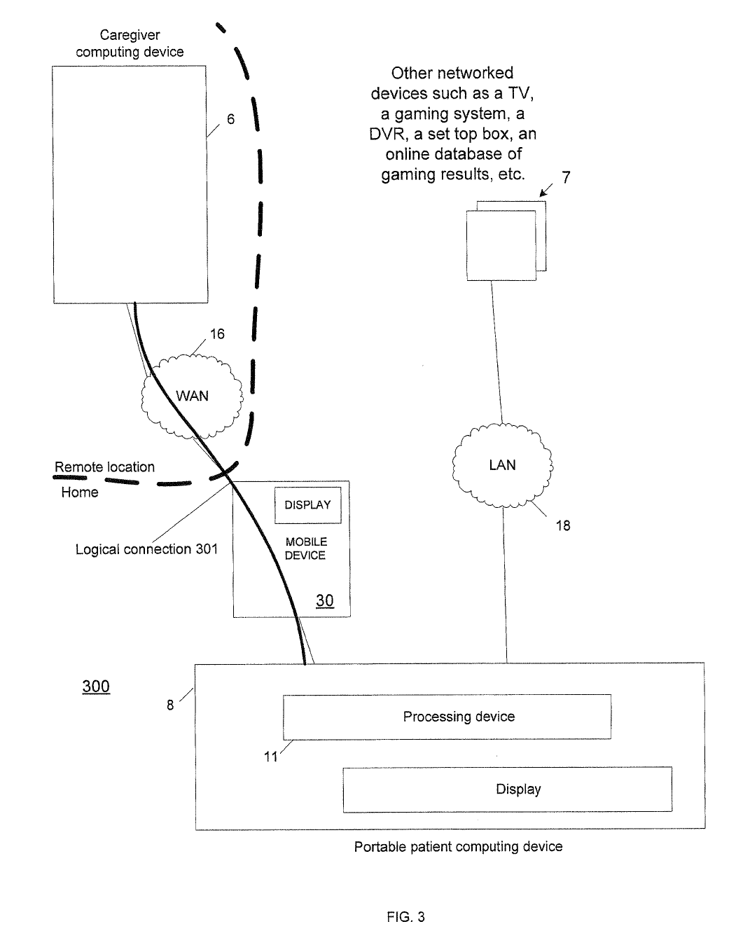

FIG. 3 illustrates the compute device communicating with the caregiver computing device through the mobile device. In the system 300, the compute station 8 8 is connected to a Local Area Network (LAN) 18. Other networked computing devices 7, as well as the mobile device 30, may interface directly with the LAN 18. The caregiver computing device 6 is accessible over a Wide Area Network (WAN) 16. By the term “WAN” we mean to include any network that covers a broad area, including but not limited to, cellular networks; satellite-based networks; the Publicly Switched Telephone Network (PSTN) and other circuit switched networks; packet switched networks, etc.

The processing device 11 is configured to detect a physical coupling (via the dock 42 or other wired connection such as USB) or a wireless coupling (for example BT 44) of the mobile device 30 to the compute station 8 as previously discussed. The processing device 11 may be configured to establish the logical connection 301 responsive to the detection. The logical connection 301 is established through the mobile device 30 using the physical connection between the mobile device 30 and the compute station 8, as well as another physical connection extending from the mobile device 30 (which may be, for example, data service connection to a cell tower).

When the mobile device 30 is not coupled to the compute station 8, the processing device 11 may attempt to communicate with the caregiver computing device 6 independently of the mobile device 30 (for example over a publicly switched telephone line or a DSL/cable connection available via the LAN 18). In some cases, one type of health monitoring communication (such as a health alert) can be sent on demand (through the mobile device 30 if available or another mechanism if the mobile device 30 is not available), while another type of health monitoring communication (such as a synchronization messages between the compute station 8 and the caregiver computing device 6) can be buffered on the compute station 8 until the next detection of the mobile device 30 coupling to the compute station 8.

Most of the equipment discussed above comprises hardware and associated software. For example, the typical portable device is likely to include one or more processors and software executable on those processors to carry out the operations described. We use the term software herein in its commonly understood sense to refer to programs or routines (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

In this application and the claims, we use the term “patient” broadly to mean any individual person whose activities are monitored consistent with the present disclosure. We use the term “caregiver” broadly to mean any person who receives notifications related to patient activities consistent with the present disclosure. “Caregiver” thus may include but is not limited to a doctor, nurse, other healthcare professional, friend, neighbor, family member, etc.

Having described and illustrated the principles of the invention in a preferred embodiment thereof, it should be apparent that the invention may be modified in arrangement and detail without departing from such principles. We claim all modifications and variations coming within the spirit and scope of the following claims.

1. A portable device, comprising:
a processing device configured to:
receive a plurality of first communications, each first communication including data indicative of activity of a patient using a first device that was captured at a corresponding time;
receive a plurality of second communications, each second communication including data indicative of activity of the patient using a second device that was captured at a corresponding time;
identify a trend based on information from the collected first and second communications;
analyze data received in a new communication from at least one of the first and second devices based on the identified trend; and
transmit a notification to a caregiver responsive to a result of the analysis; and
a network connection coupled to the processing device, the network connection configured to utilize a network protocol to interface with a remote display and output an image related to the result of the analysis on the remote display.

2. The portable device of claim 1, wherein the processing device is further configured to:
detect a wireless or physical coupling of a mobile device to the portable device; and
responsive to said detection, download an application to the mobile device;
wherein the downloaded application enables the mobile device to send the plurality of first communications.

3. The portable device of claim 2, wherein the processing device is further configured to:
discover a characteristic of the display of the coupled mobile device;
select one of a plurality of display parameters according to the discovered characteristic; and
instruct the mobile device to display a Graphical User Interface (GUI) according to the selected display parameter.

4. The portable device of claim 3, wherein the processing device is further configured to:
generate display content based on the result of the analysis; and
instruct the mobile device to display the generated content responsive to operation of the GUI.

5. The portable device of claim 1, wherein the processing device is further configured to drive an output interface of the mobile device by transmitting signaling to the downloaded application.

6. The portable device of claim 5, wherein the processing device is further configured to:
receive signaling indicating inputs originating from an input interface of the mobile device; and
drive the output interface of the mobile device according to the inputs indicated by the received signaling.

7. The portable device of claim 1, wherein the mobile device comprises a platform independent personal computing device.

8. The portable device of claim 7, wherein the platform independent personal computing device comprises a cellular telephone.

9. The portable device of claim 8, wherein the processing device further is configured to utilize an interactive display device of the cellular telephone as an extended input and output interface of the portable device.

10. The portable device of claim 1, wherein the processing device is further configured to transmit the notification to the caregiver over a logical connection that extends over at least two physical connections, the first physical connection being a short range wireless connection or wired connection extending between the portable device and mobile device, and the second physical connection being a greater range wireless connection between the mobile device and a remote device.

11. The portable device of claim 10, wherein the portable device operates on a Local Area Network (LAN), and wherein at least one of the communications originates from the LAN, and wherein the logical connection extends over a Wide Area Network (WAN).

12. A method, comprising:
receiving, at a patient computing device operating on a Local Area Network (LAN), a plurality of first communications, each first communication including data indicative of activity of a patient using a first device that was captured at a corresponding time;
receiving, at the patient computing device, a plurality of second communications, each second communication including data indicative of activity of the patient using a second device that was captured at a corresponding time;
wherein at least some of the first or second communications originate from within the LAN;
identifying a trend corresponding to a patient based on information from the collected first and second communications;
analyzing data received in a new communication from at least one of the first and second devices relative to the identified trend;
transmitting a notification over a Wide Area Network (WAN) to a caregiver computing device responsive to the analysis; and
interfacing with a remote display using a network protocol to cause an image related to the result of the analysis to be output on the remote display.

13. The method of claim 12, further comprising:
detecting a wireless or physical coupling of a mobile device to the patient computing device; and
responsive to said detection, configuring an application on the mobile device;
wherein the application enables the mobile device to send the plurality of first communications.

14. The method of claim 13, further comprising:
discovering a characteristic of the display of the coupled mobile device;
selecting one of a plurality of display parameters according to the discovered characteristic; and
instructing the mobile device to display a Graphical User Interface (GUI) according to the selected display parameter.

15. The method of claim 14, further comprising:
generating display content based on the result of the analysis; and
instructing the mobile device to display the generated content responsive to operation of the GUI.

16. The method of claim 12, further comprising driving an output interface of the mobile device by transmitting signaling to the application.

17. The method of claim 16, further comprising:
receiving signaling indicating inputs originating from an input interface of the mobile device; and
driving the output interface of the mobile device according to the inputs indicated by the received signaling.

18. The method of claim 12, wherein the mobile device comprises a cellular telephone.

19. The method of claim 18, further comprising utilizing an interactive display of the cellular telephone as an extended input and output interface of the patient computing device.

20. The method of claim 12, further comprising transmitting the notification to the caregiver computing device over a logical connection that extends over at least two physical connections, the first physical connection being a short range wireless connection or wired connection extending between the patient computing device and the mobile device, and the second physical connection being a greater range wireless connection between the mobile device and a remote device.
